(19) United States
(12) Patent Application Publication
(10) Pub. No.: US 2023/0012364 A1
(43) Pub. Date: Jan. 12, 2023

(54) METHOD OF MAKING AN ORTHODONTIC APPLIANCE

(71) Applicant: 3C, LE BLANC-MESNIL (FR)

(72) Inventors: Harry MELKA, PARIS (FR); Gabriel DRAI, SAINT-MAUR-DES-FOSSES (FR); Mickael SAADA, PARIS (FR); Paul COUDERC, PANTIN (FR)

(21) Appl. No.: 17/858,440

(22) Filed: Jul. 6, 2022

(30) Foreign Application Priority Data
Jul. 7, 2021 (FR) 21 07343

(51) Int. Cl. A61C 7/00; A61C 7/20

(52) U.S. Cl. CPC A61C 7/002; A61C 7/20; A61C 2201/007; A61C 2007/004

(57) ABSTRACT

Disclosed is a method for manufacturing an orthodontic appliance, including the following steps: producing a scanned image of a row of teeth in an initial position; then in a position sought; then producing of a scanned image of the orthodontic appliance, the appliance including an orthodontic arch and at least one fastening element for attachment to a tooth. The orthodontic device is configured for being assembled to the row of teeth in the initial position, so that the arch will take a planar shape when the row has moved into the position sought. The method further includes the following steps: producing a scanned image of the orthodontic arch in the planar shape; then manufacturing the arch from the image by cutting a plate of solid shape memory material.

### BACKGROUND OF THE INVENTION

### Field of the Invention

The present invention relates to a method of making an orthodontic appliance, said orthodontic appliance being configured for being assembled with a row of teeth of a patient so as to make said row of teeth move from a first initial position to a second position sought, the method comprising the following steps: taking a first scanned image of the row of teeth in the first initial position; then, starting from the first scanned image, taking a second scanned image of the row of teeth in the second scanned position; then taking, starting from the first and second scanned images, a third scanned image of the orthodontic appliance, said orthodontic appliance comprising an orthodontic arch and at least one element for fastening to a tooth of the row.

The present invention particularly applies to orthodontic appliances of the lingual type, arranged on the posterior non-visible side of the teeth. The present invention further applies to vestibular-type orthodontic appliances, arranged on the visible anterior side of the teeth.

### Description of the Related Art

The term “orthodontic appliance” refers preferentially to an appliance called active appliance, apt to exert on the teeth of a patient a force tending to move said teeth from the initial position which is considered unsatisfactory, to a position sought, in particular corresponding to an alignment of the teeth.

It is known at least partially, how to make orthodontic appliances of shape memory materials, so that teeth move to the desired position. E.g. application FR 20 13000 authored by the applicant and not yet published, describes the making of such an orthodontic appliance from a numerically designed image.

In the above-mentioned application, the orthodontic appliance is produced by 3D printing, which requires appropriate equipment.

In particular, the invention is intended to be used in making an orthodontic appliance from more accessible equipment.

### SUMMARY OF THE INVENTION

For this purpose, the subject matter is a manufacturing method of the above-mentioned type, wherein: the orthodontic appliance is configured for being assembled with a row of teeth in the first position, so that the orthodontic arch takes a substantially planar shape when said row of teeth is moved to the second position; and the method then includes the following steps: producing, from the third scanned image, a fourth scanned image of the orthodontic arch in the said substantially planar shape; then manufacturing the orthodontic arch from the fourth image, said manufacturing comprising a step of cutting a plate of a solid shape memory material.

According to other advantageous aspects of the invention, the manufacturing method comprises one or more of the following characteristics, taken individually or according to all technically possible combinations:
the solid shape memory material is nitinol;
the cutting step is performed while the nitinol plate is at least partially immersed in water at a temperature apt to maintain said nitinol plate in the austenitic phase;
the cutting of the plate of solid shape memory material is performed by a means chosen from a single laser beam, a laser beam surrounded by a water jet and a high-pressure water jet with abrasive particles;
the manufacturing method then includes a step of assembling the orthodontic arch with at least one element for fastening to the tooth of a patient, so as to form the orthodontic appliance.

The invention further relates to a cutting tool for the implementation of the cutting of a plate of solid shape memory material, said tool comprising: a cutting nozzle, extending along a main axis; and a plate holding system, said holding system comprising: a first element rigidly attached to the cutting nozzle; and a second element comprising: a frontal surface, apt to be brought into contact with the plate; and a central through hole opening onto said frontal surface; the second element is movable in translation along the main axis, with respect to the first element, the cutting nozzle being apt to slide into the central hole.

According to other advantageous aspects of the invention, the cutting tool includes one or more of the following characteristics, taken individually or according to all technically possible combinations:
the holding system includes: a connecting rod, apt to determine a maximum axial distance between the first and second elements; and a compression spring, arranged between said first and second elements, said spring being in a non-zero compression state at the maximum axial distance between the first and second elements;
the appliance comprises a plurality of connecting rods and a plurality of compression springs arranged angularly around the main axis;
the cutting nozzle is equipped with means of cutting chosen from a laser beam alone, a laser beam surrounded by a water jet and a high-pressure water jet with abrasive particles.

The present invention further relates to a method for manufacturing an orthodontic appliance as described above, wherein the step of cutting the plate of solid shape memory material is performed using a cutting tool as described above.

### BRIEF DESCRIPTION OF THE DRAWINGS

The invention will be better understood upon reading the following description, given only as a non-limiting example and making reference to the drawings wherein:

FIG. 1 is a top view of an orthodontic appliance made using a manufacturing method according to an embodiment of the invention;

FIG. 2 is a view of a step of the manufacturing method for the orthodontic appliance shown in FIG. 1;

FIG. 3 is a schematic view of an installation for performing the step of manufacturing method, as shown in FIG. 2;

FIGS. 4 and 5 are views of an appliance included in the installation shown in FIG. 3 according to a variant of an embodiment of the invention; and

FIG. 6 is a flowchart of the steps of a manufacturing method according to an embodiment of the invention.

### DESCRIPTION OF THE PREFERRED EMBODIMENTS

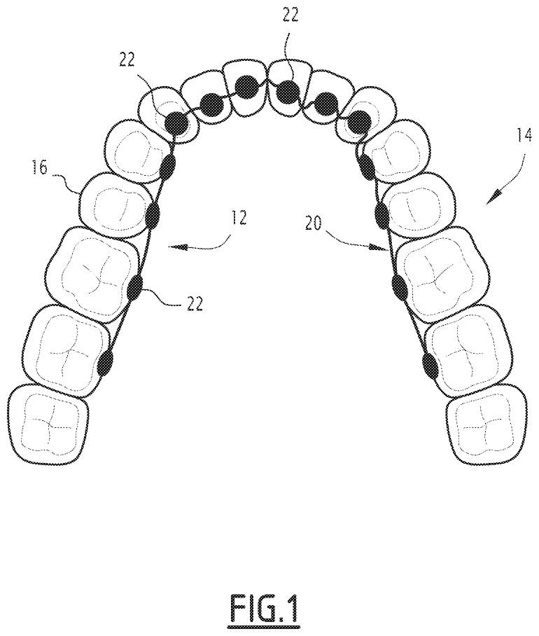

FIG. 1 shows an orthodontic appliance 12 assembled with a row 14 of teeth 16 of a patient.

In the embodiment shown, the orthodontic appliance 12 is configured for being assembled with a posterior side of the teeth 16. In other words, the orthodontic appliance 12 is a lingual device.

In a variant not shown, the orthodontic appliance is configured for being assembled with a visible anterior side of the teeth, the orthodontic appliance being a so-called vestibular appliance.

The orthodontic appliance 12 comprises an orthodontic arch 20 and a plurality of fastening elements 22.

The orthodontic arch 20 has substantially the shape of a wire made of a solid shape memory material. Preferentially, the solid material is a metal.

More preferentially, the orthodontic arch 20 is made of nitinol. Nitinol is an alloy of nickel and titanium in ratios close to 1:1.

In the solid state, nitinol is known for the reversible transformation properties thereof. At high temperatures, nitinol has a crystalline cubic primitive structure, called austenitic state. At low temperatures, nitinol spontaneously transforms into a more complex crystal structure, called martensitic state. The reversible change of structure occurs at a transformation temperature. Said temperature is between 0° C. and 45° C.

Such properties lead to the shape memory of nitinol and to super-elasticity. Super-elasticity appears at temperatures just above the transformation temperature.

The fastening elements 22 are arranged along the orthodontic arch 20. Each fastening element 22 of the orthodontic appliance 12 is intended to be attached to a distinct tooth 16 of the row 14.

According to one embodiment, at least one fastening element 22 is mounted fixed on the orthodontic arch 20. According to another embodiment, at least one fastening element 22 is mounted sliding on the orthodontic arch 20. The fastening elements 22 are e.g. brackets or beads.

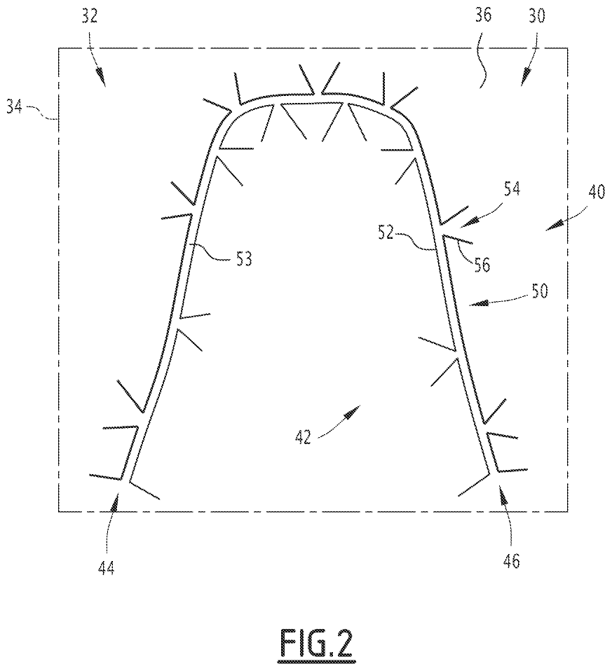

FIG. 2 shows a fabrication step of a method for manufacturing the orthodontic arch 20.

More specifically, FIG. 2 shows a plate 30 of solid shape memory material, and a cut-out 32 provided in said plate 30.

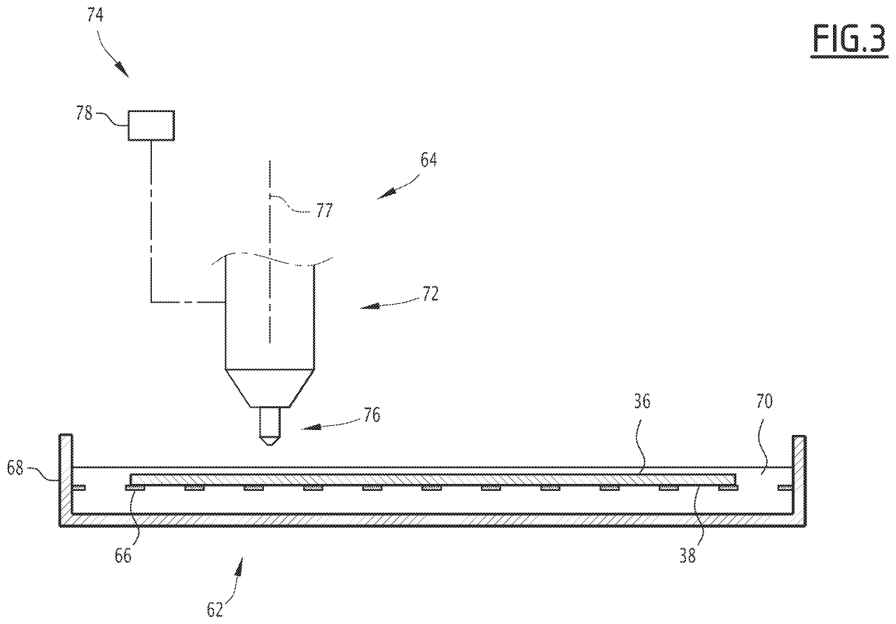

The plate 30, which is also visible in FIG. 3, is delimited by edges 34 and has a first 36 and a second 38 opposite sides. Only the first side 36 is visible in FIG. 2. The plate 30 has a relatively small thickness between the first 36 and the second 38 sides, said thickness being comprised e.g. between 0.1 mm and 2 mm.

The cut-out 32 is preferentially positioned at a non-zero distance from the edges 34 of the plate 30.

The cut-out 32 has a generally overall concave shape, corresponding to a shape of the orthodontic arch 20. The cut-out 32 has an outer part 40 and an inner part 42 which extend substantially parallel. The terms “outer” and “inner” refer to the concavity of the cut-out 32.

The cut-out 32 has a first end 44 and a second end 46, in-between which extends each of the outer 40 and inner 42 parts.

Each of the outer part 40 and the inner part 42 of the cut-out 32 has at least one slot extending continuously over the plate 30 between two closed ends, said slot being crossing through between the first side 36 and the second side 38.

Preferentially, between the first end 44 and the second end 46, at least one of the outer 40 and inner 42 parts of the cut-out 32 is discontinuous. In the embodiment shown, each of the outer 40 and inner 42 parts of the cut-out 32 is discontinuous.

“Discontinuous” means that the outer part 40 and/or inner part 42 includes a plurality of sections 50. Each section 50 forms a slot extending continuously over the plate 30 between two closed ends, said slot crossing through between the first side 36 and the second side 38.

Each section 50 includes at least one central portion 52, said central portions of the sections drawing a profile of the orthodontic arch 20. The zone 53 of the plate 30 arranged between the central portions 52 of the sections 50 of the outer part 40 and the central portions 52 of the sections 50 of the inner part 42, is intended to form said orthodontic arch.

The central portions 52 of two consecutive sections 50 of the outer part 40 or inner part 42 are separated by an anchorage 54, formed by the plate 30. Said anchorage 54 has a small length compared with the central portions 52, however said length is not zero.

Preferentially, at least one section 50 further includes two end portions 56, extending each end of the central portion 52. Each end portion 56 is substantially rectilinear, has a small length compared with the central portion 52 and is substantially tilted with respect to said central portion.

In the embodiment shown, each section 50 has two end portions 56 as described above. The end portions 56 of two consecutive sections 50, located on either side of the same anchorage 54, substantially form a V shape

As shown in FIG. 2, the end portions 56 of the sections 50 of the outer part 40 are facing outwards from the cavity of the cut-out 32; and conversely, the end portions 56 of the sections 50 of the inner part 42 are facing inwards towards the concavity of said cut-out.

FIG. 3 is a schematic view of an installation 60 for implementing a method for manufacturing an orthodontic arch 20. The installation 60 relates in particular to how to make the cut-out 32 in the plate 30, as described above.

The installation 60 has a support 62 which receives the plate 30, and a cutting tool 64.

The support 62 preferentially has a horizontal surface, coming into contact with a side 38 of the plate 30. In the embodiment shown, said horizontal surface is a grid 66, e.g. a metal grid.

In the embodiment shown, the support 62 further comprises a tank 68 to which the edges of the grid 66 are attached. As will be discussed in detail later, said tank is used to immerse the plate 30 into water 70 during the cutting step.

Optionally, the support 62 further includes means of fastening (not shown) of the plate 30 to the grid 66, e.g. clamps apt to be assembled with the edges of said plate.

The cutter 64 includes a cutting tool 72 and a control system 74. The cutting tool 72 has in particular, a nozzle 76 extending along an axis 77. In the embodiment shown, axis 77 is vertical.

Preferentially, the cutting tool 72 is apt to cut the plate 30 according to a method chosen from the projection of a water jet loaded with abrasive particles, a laser emission or even a laser emission guided by a water jet.

The control system 74 comprises: a motorized arm (not shown) apt to move the nozzle 76 of the cutting tool parallel to the surface of the plate 30; and an electronic control module 78, apt to control the said motorized arm for the movement of the nozzle 76 and for the operation of the cutting tool 72.

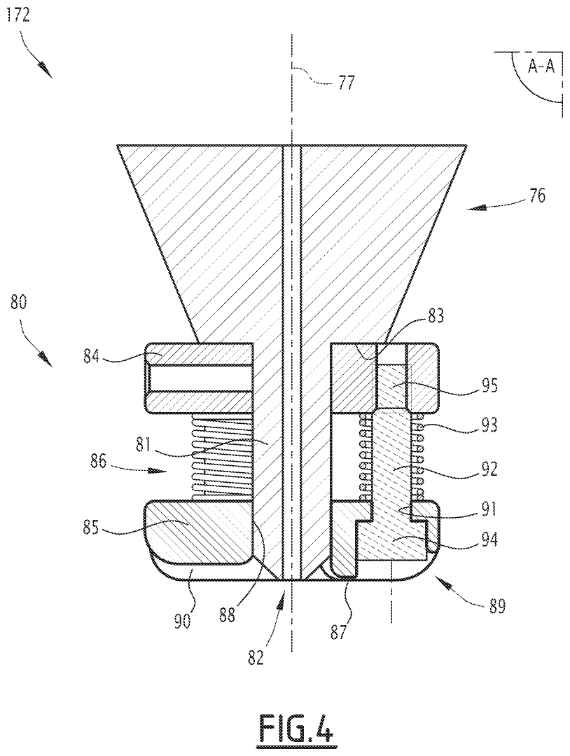

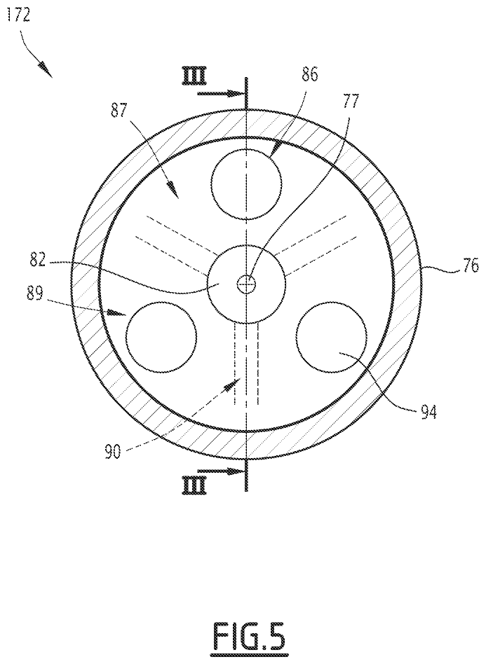

FIGS. 4 and 5 show a variant 172 of the embodiment of the cutting tool. The cutting tool 172 is apt to replace the tool 72 in the installation 60 as described above.

In said embodiment, the cutting tool 172 comprises a nozzle 76 as described above and a holding component 80 assembled to said nozzle.

As shown in the section view in FIG. 4, the nozzle 76 has a barrel 81 with a shape which is substantially a cylinder of revolution, extending along the axis 77 between an exit end 82 and a shoulder 83.

The holding component 80 includes: a fastening washer 84, a thrust washer 85 and at least two connecting elements 86.

Each of the fastening washers 84 and thrust washers 85 is perforated in the center thereof and is intended to take place around the nozzle barrel 81.

The fastening washer 84 is attached to said barrel, resting on the shoulder 83.

The thrust washer 85 has a thrust surface 87 intended to come into contact with the plate 30 during the cutting step. Preferentially, said surface 87 is made of a material apt to minimize friction, such as PVC.

The thrust washer 85 further comprises: a central hole 88, intended to receive the barrel 81 of the nozzle; at least two cavities 89, intended to receive the connecting elements 86; and at least two grooves 90, extending between the central hole 88 and a periphery of the thrust washer. The cavities 89 and the grooves 90 are hollowed out with respect to the thrust surface 87.

Each cavity 89 is extended by an opening 91 crossing through the thrust washer 85.

Each of the connecting elements 86 includes a screw 92 and a spring 93. Each screw 92 extends parallel to the axis 77 and has a smooth shaft, each end of said shaft being extended by an enlarged head 94 and by a threaded portion 95, respectively. The enlarged head has transverse dimensions greater than the diameter of the opening 91.

The threaded portion 95 of each screw 92 is assembled with the fastening washer 84. The shaft of each screw 92 crosses through an opening 91, the corresponding enlarged head 94 being arranged in the cavity 89 leading to said opening.

Thus, the thrust washer 85 is apt to slide along the barrel 81 of the nozzle and the screws 92 of the connecting elements, the amplitude of said sliding along the axis 77 being limited by the stop of the screw heads 94 at the bottom of the cavities 89.

The spring 93 of each connecting element 86 is a compression coil spring, arranged around the shaft of the screw 92. Each spring 93 is compressed when the holding component is assembled. Thus, each of the said springs exerts a force against the fastening washers 84 and the thrust washers 85, so as to move the washers axially away from each other.

In the embodiment shown, the holding component 80 includes three connecting elements 86, arranged angularly and regularly around the barrel 81 of the nozzle. In a similar way, the thrust washer 85 comprises three cavities 89 and three grooves 90. Each groove 90 is arranged between two cavities 89.

During the assembly of the nozzle 76 and the holding element 80, by screwing the screws 92 into the fastening washer 84, the axial distance from the thrust washer 85 is adjusted so that the exit end 82 of the barrel 81 is flush with the thrust surface 87.

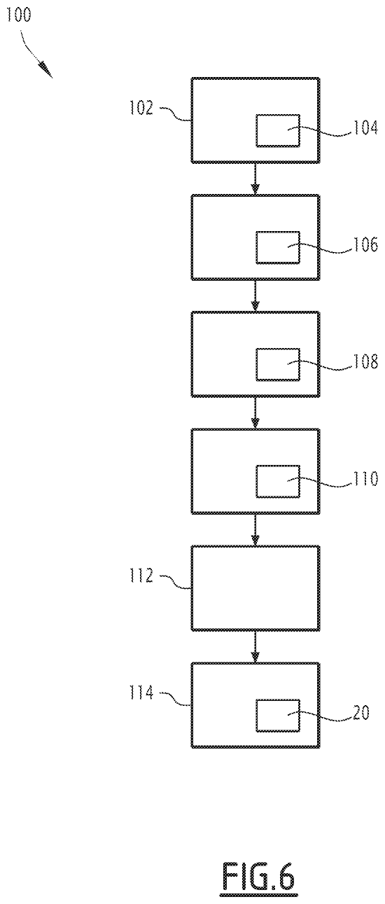

A method 100 for manufacturing the orthodontic appliance 12 will now be described, with support from FIG. 6.

In a first step 102, the row 14 of teeth 16 of the patient to be treated is modeled by scanning the jaw of said patient. The teeth are then in a first position, called the initial position. A scanned image 104 of the row of teeth is produced.

From the scanned image 104 of the teeth in the initial position, a modified image 106 is then constructed using appropriate software. This modified image 106, or setup, corresponds to a second position sought for the teeth of the patient.

Using appropriate software, a scanned image 108 of the orthodontic appliance 12 is then produced from the scanned image 104 of the teeth in the initial position, and from the setup 106.

The scanned image 108 comprises, in particular, the shape and dimensions of the orthodontic appliance 12 apt to change the row 14 of teeth from the first initial position to the second position sought. The orthodontic appliance 12 modeled in the image 108 comprises the orthodontic arch 20 and the plurality of fastening elements 22 as previously described.

Furthermore, the shape and dimensions of the orthodontic appliance 12 as defined in the scanned image 108 are such that the orthodontic arch 20 takes a substantially planar shape when the row 14 of teeth, assembled with the orthodontic appliance 12, is in the second position sought.

The scanned image 108 of the orthodontic appliance 12 is then processed to extract the image of the orthodontic arch 20 of the said substantially planar form; and said image of the orthodontic arch 20 undergoes additional processing so as to extract a scanned image 110 of the cut-out 32 as described above, integrating the sections 50 and the fasteners 34.

The said scanned image 110 of the cut-out 32 is sent to the electronic control module 78 of the installation 60 as described above.

The manufacturing method 100 then includes a step 112 of performing the cut-out 32 in a plate 30 of shape memory material, using said installation 60. The step 112 takes place as follows:

The plate 30 is first of all arranged on the grid 66 of the support 62 and preferentially same is attached to the support.

When the plate 30 is made of nitinol, the tank 68 is preferentially filled with water 70 in the liquid state, so as to immerse said plate 30. The water 70 is more preferentially maintained at a temperature apt to maintain said nitinol plate in the austenitic phase and in the super-elastic state. The water temperature is e.g. comprised between 40° C. and 100° C.

The cutting tool 64 is then put in operation. The control system 74 moves the nozzle 76 over the plate 30 so as to reproduce the outline of the cut-out 32 as modeled by the scanned image 110. The electronic module 78 initiates the operation of the cutting tool 72 in the places corresponding to the sections 50 of said cut-out and stops said operation in the places corresponding to the anchorages 34.

The presence of the end portions 56 in the configuration of the sections 50 leads to a better accuracy of the outline of the central portions 52, as produced by the cutting tool, and holds the orthodontic arch 20 during cutting.

Maintaining the plate in the super-elastic state prevents inadvertent deformations of said plate during cutting.

In a variant of the cutting tool 72 in FIG. 3, the installation 60 includes the cutting tool 172 as shown in FIGS. 4 and 5. In such a case, during the movement of the nozzle 76 over the plate 30, the thrust surface 87 will slide in contact with the first side 36 of the plate 30. The springs 93 of the connecting elements 86 allow said surface 87 to stay pressed against the plate 30 during the movement. In this way, inadvertent movements of the said plate are prevented, leading to better accuracy for the outline of the cut-out 32.

If the cutting tool 72 operates using a laser beam surrounded by a water jet or by a high-pressure water jet with abrasive particles, the grooves 90 make it possible to laterally drain the water sprayed by the nozzle 76. Said draining reduces the risk of clogging the nozzle 76 with particles displaced by the water.

The plate 30 wherein the cut-out 32 is made, as shown in FIG. 2, is thus produced.

During a step 114, the orthodontic arch 20 is then extracted from the plate 30 by sectioning the anchorages 34, e.g. using a hand tool.

To make the orthodontic appliance 12, the orthodontic arch 20 produced in this way, is then assembled with the fastening elements 22.

The orthodontic appliance 12 is then placed on the teeth 16 of the patient following known methods, the teeth then being in the first initial position.

During this installation step, the orthodontic arch 20 is deformed and loses the substantially planar shape thereof. The properties of the shape memory of said arch determine the return of said arch to the shape thereof, which exerts a force on the teeth 16 tending to move the teeth to the second position sought.

According to one embodiment, the step 112 of the cut-out as described above is configured so as to successively make a plurality of cut-outs 32 distributed across the surface of the plate 30, each cut-out 32 corresponding to a particular orthodontic arch 20 which will lead to a particular orthodontic appliance 12. Such a step 112 thus optimizes the use of the installation 60 for the simultaneous manufacturing of a plurality of orthodontic appliances.

1. A method for manufacturing an orthodontic appliance, said orthodontic appliance being configured for being assembled with a row of teeth of a patient so as to make said row of teeth move from a first initial position to a second position sought, the method comprising the following steps:
producing a first scanned image of the row of teeth in the first initial position; then
producing a second scanned image of the row of teeth in the second position sought, starting from the first scanned image; then
producing, from the first and second scanned images, a third scanned image of the orthodontic appliance, said orthodontic appliance comprising an orthodontic arch and at least one fastening element for attachment to a tooth of the row;
wherein:
the orthodontic appliance is configured for being assembled with the row of teeth in the first position, so that the orthodontic arch takes a substantially planar shape when said row of teeth moves into the second position; and
the method further comprises the following steps: producing, from the third scanned image, a fourth scanned image of the orthodontic arch in said substantially planar shape; then manufacturing the orthodontic arch from the fourth image, said manufacturing comprising a step of cutting a plate of a solid shape memory material.

2. The manufacturing method according to claim 1, wherein the solid shape memory material is nitinol.

3. The manufacturing method according to claim 2, wherein the cutting step is carried out while the nitinol plate is at least partially immersed in water at a temperature apt to maintain said nitinol plate in the austenitic phase.

4. The manufacturing method according to claim 1, wherein the cutting of the plate of solid shape memory material is performed by a means chosen from a laser beam alone, a laser beam surrounded by a water jet and a high-pressure water jet with abrasive particles.

5. The manufacturing method according to claim 1, further comprising an assembly step for the orthodontic arch with at least one fastening element for the attachment to a tooth of the patient, so as to form the orthodontic appliance.

6. A cutting tool for the implementation of the cutting of a plate of a solid shape memory material, said tool comprising:
a cutting nozzle extending along a main axis; and
a system for holding the plate,
said holding system comprising:
a first element rigidly attached to the cutting nozzle; and
a second element, comprising: a frontal surface, apt to come into contact with the plate; and a central through hole leading to said frontal surface;
the second element being movable in translation along the main axis with respect to first element, the cutting nozzle being apt to slide inside the central hole.

7. The appliance according to claim 6, wherein the holding system comprises: a connecting rod, apt to determine a maximum axial distance between the first and second elements; and a compression spring, placed between said first and second elements, said spring being in a non-zero compression state at the maximum axial distance between the first and second elements.

8. The appliance according to claim 7, comprising a plurality of connecting rods and a plurality of compression springs arranged angularly around the main axis.

9. The appliance according to claim 6, wherein the cutting nozzle is equipped with cutting means chosen from a single laser beam, a laser beam surrounded by a water jet and a high-pressure water jet with abrasive particles.

10. The method for manufacturing an orthodontic appliance according to claim 1, wherein the step of cutting the plate of solid shape memory material is performed using a cutting tool for the implementation of the cutting of a plate of a solid shape memory material, said tool comprising:
a cutting nozzle extending along a main axis; and
a system for holding the plate,
said holding system comprising:
a first element rigidly attached to the cutting nozzle; and
a second element, comprising: a frontal surface, apt to come into contact with the plate; and a central through hole leading to said frontal surface;
the second element being movable in translation along the main axis with respect to first element, the cutting nozzle being apt to slide inside the central hole.

11. The manufacturing method according to claim 2, wherein the cutting of the plate of solid shape memory material is performed by a means chosen from a laser beam alone, a laser beam surrounded by a water jet and a high-pressure water jet with abrasive particles.

12. The manufacturing method according to claim 3, wherein the cutting of the plate of solid shape memory material is performed by a means chosen from a laser beam alone, a laser beam surrounded by a water jet and a high-pressure water jet with abrasive particles.

13. The manufacturing method according to claim 2, further comprising an assembly step for the orthodontic arch with at least one fastening element for the attachment to a tooth of the patient, so as to form the orthodontic appliance.

14. The manufacturing method according to claim 3, further comprising an assembly step for the orthodontic arch with at least one fastening element for the attachment to a tooth of the patient, so as to form the orthodontic appliance.

15. The manufacturing method according to claim 4, further comprising an assembly step for the orthodontic arch with at least one fastening element for the attachment to a tooth of the patient, so as to form the orthodontic appliance.

16. The appliance according to claim 7, wherein the cutting nozzle is equipped with cutting means chosen from a single laser beam, a laser beam surrounded by a water jet and a high-pressure water jet with abrasive particles.

17. The appliance according to claim 8, wherein the cutting nozzle is equipped with cutting means chosen from a single laser beam, a laser beam surrounded by a water jet and a high-pressure water jet with abrasive particles.

18. The method for manufacturing an orthodontic appliance according to claim 2, wherein the step of cutting the plate of solid shape memory material is performed using a cutting tool for the implementation of the cutting of a plate of a solid shape memory material, said tool comprising:
a cutting nozzle extending along a main axis; and
a system for holding the plate,
said holding system comprising:
a first element rigidly attached to the cutting nozzle; and
a second element, comprising: a frontal surface, apt to come into contact with the plate; and a central through hole leading to said frontal surface;
the second element being movable in translation along the main axis with respect to first element, the cutting nozzle being apt to slide inside the central hole.

19. The method for manufacturing an orthodontic appliance according to claim 3, wherein the step of cutting the plate of solid shape memory material is performed using a cutting tool for the implementation of the cutting of a plate of a solid shape memory material, said tool comprising:
a cutting nozzle extending along a main axis; and
a system for holding the plate,
said holding system comprising:
a first element rigidly attached to the cutting nozzle; and
a second element, comprising: a frontal surface, apt to come into contact with the plate; and a central through hole leading to said frontal surface;
the second element being movable in translation along the main axis with respect to first element, the cutting nozzle being apt to slide inside the central hole.

20. The method for manufacturing an orthodontic appliance according to claim 4, wherein the step of cutting the plate of solid shape memory material is performed using a cutting tool for the implementation of the cutting of a plate of a solid shape memory material, said tool comprising:
a cutting nozzle extending along a main axis; and
a system for holding the plate,
said holding system comprising:
a first element rigidly attached to the cutting nozzle; and
a second element, comprising: a frontal surface, apt to come into contact with the plate; and a central through hole leading to said frontal surface;
the second element being movable in translation along the main axis with respect to first element, the cutting nozzle being apt to slide inside the central hole.
